(19) United States
(12) Patent Application Publication
(10) Pub. No.: US 2022/0364464 A1
(43) Pub. Date: Nov. 17, 2022

(54) IMPROVEMENTS IN OR RELATING TO ASSESSMENT OF MINING DEPOSITS

(71) Applicant: RIG TECHNOLOGIES INTERNATIONAL PTY LTD, Welshpool (AU)

(72) Inventor: Timothy Andrew John Hopper, Perth (AU)

(73) Assignee: RIG TECHNOLOGIES INTERNATIONAL PTY LTD, Welshpool (AU)

(21) Appl. No.: 17/766,061

(22) PCT Filed: Oct. 2, 2020
(86) PCT No.: PCT/AU2020/051063

§ 371 Date: Apr. 1, 2022

(30) Foreign Application Priority Data
Oct. 2, 2019 (AU) 2019903706

(51) Int. Cl. E21B 49/00; E21B 47/04

(52) U.S. Cl. CPC E21B 49/003; E21B 47/04

(57) ABSTRACT

In one aspect, a system (5) for use in providing an approximation or estimation of a characteristic (for example, a bulk density value) of a deposit subject to a drilling operation is disclosed. In one form, the system (5) comprises a processor module (25) arranged in operable association with a network of sensors (30) operable for measuring one or more parameters relating to the operation of the drilling assembly (10). The processor module (25) is configured operable for receiving data/information derived from the network of sensors (30), and processing the data/information so as to provide a representation of the incursion (eg. depth of penetration into the relevant deposit) achieved by way of the drilling assembly (10). The processor module (25) is further configured for processing the representation of the incursion with a predetermined relationship that is characteristic of, or unique to, the drilling assembly (10) for providing or allowing an approximation/estimation of the characteristic of the deposit as a function of one or more parameters of the incursion to be made.

### TECHNICAL FIELD

In at least one aspect, a system and related method for use in providing an approximation or estimation of a characteristic of a deposit subject to a drilling operation by way of a drilling assembly is disclosed.

### BACKGROUND

Each document, reference, patent application or patent cited in this text is expressly incorporated herein in their entirety by reference, which means that it should be read and considered by the reader as part of this text. That the document, reference, patent application, or patent cited in this text is not repeated herein is merely for reasons of conciseness.

In this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive concept/principles may be exemplified.

In at least iron ore exploration it is desirable to obtain a sample of an ore deposit to determine example qualities of the deposit for potential mining purposes. Typically boreholes are drilled using reverse circulation (RC) drilling equipment in exploratory drilling operations to obtain these samples. RC drilling generally use drilling rods having inner and outer tubes, whereby the drill cuttings are returned to the surface inside the rods. The drilling mechanism usually includes a pneumatic reciprocating piston (known as a hammer) configured for driving a generally tungsten-steel hardened drill bit. In general, RC drilling utilises much larger rigs and machinery and are usually capable of drilling to depths of up to 500 metres. RC drilling ideally produces dry rock chips, as large air compressors dry the rock out ahead of the advancing drill bit.

RC is achieved by blowing air down an annulus of the drill rod, the differential pressure creating air lift off the water and cuttings up the inner tube which is inside each drill rod. It reaches a deflector box at the top of the drill string then moves through a sample hose which is attached to the top of a cyclone. The drill cuttings travel around the inside of the cyclone until they fall through an opening at the bottom and are collected in a sample bag. For any drilled borehole there will be a large number of sample bags, each one marked to record the location and drilling depth that the sample was obtained. The collected series of sample bag cuttings are later taken for analysis to determine the mineral composition of the borehole. The analysis results of each individual bag represents the mineral composition at a particular sample section in the borehole. Geologists can then survey the drilled ground analysis and make decisions about the value of the overall mineral deposit.

In some respects, as compared other forms of drilling, use of RC drilling can be advantageous depending on the outcome required. In some situations, RC drilling can be slower and costlier but can achieve better penetration than, for example, rotary air blast (RAB) or air core drilling (ACD). RC drilling is cheaper than diamond coring and is therefore preferred for most mineral exploration work. However, in some situations the speed of the operation is not a key priority—and is balanced against desired cuttings/core qualities. At present, after each new borehole has been drilled, an inclination and azimuth survey tool is deployed on a wireline to log the borehole's trajectory. One or more additional wireline runs are then performed to log various geophysical properties.

To avoid many of the deficiencies in current drilling processes, there is interest in seeking to develop systems/processes capable of avoiding the need to undertake subsequent wirelines runs in a drilled borehole.

It is against this background that the embodiments described herein have been developed.

### SUMMARY

According to a first principal aspect, there is provided a system for use in providing an approximation or estimation of a characteristic of a deposit subject to a drilling operation by way of a drilling assembly, the system comprising:
a processor module configured operable for receiving data/information derived from a network of sensors operable for measuring one or more parameters relating to the operation of the drilling assembly, and processing the data/information so as to provide a representation of incursion into the deposit achieved by way of the drilling assembly as a function of depth,
the processor module further configured for processing said representation in accordance with a predetermined relationship characteristic of or unique to the drilling assembly for providing an approximation or estimation of the characteristic of the deposit as a function of one or more parameters representative of the incursion.

In the assessment of the value of a target ore deposit it is usual to determine and consider measures of the density of the deposit. A number of density measures can be considered such as for example, dry bulk density, insitu bulk density, and specific gravity density. Observations involving dry bulk density and specific gravity often involve methods being labour intensive in nature which can lead to lower sample rates and, consequently, less than desirable density data. In contrast, geophysical borehole logging for density is a commonly used practice for at least its more precise technique which often leads to the generation of a large dataset of information for modelling purposes. Generally speaking, geophysical borehole density logging is a rapid and precise method of generating an extensive segment of bulk density data/information. In many forms, geophysical borehole density logging utilizes back scattered laterally projected (with respect to the length of the borehole) gamma radiation from a small radioactive source within the geophysical probe. Quality control of the density measurements can be achieved by using caliper data (from the same probe) to identify zones of enlargements or washouts where measurements may be compromised. Dry density values can be generated from a geophysical density data set with knowledge of the water filled porosity.

Embodiments of the system and method operable in accordance with the principles described herein seek, in at least one respect, to avoid the need for subsequent (and specific) wireline runs being carried out down the borehole once it is drilled (as is the case for conventional exploratory drilling). Instead, such embodiments of the system (and method) allow for a metric indicative of the value of the deposit being drilled/explored to be developed/determined while the borehole is being drilled. In this manner, significant savings in operational time (and associated cost) have the potential to be achieved.

Accordingly, in one embodiment of the system consistent with the principles described herein, the characteristic of the deposit, of which an approximation is sought, is its density or bulk density.

In one embodiment, one of the one or more parameters representative of the incursion is the rate of penetration (usually in the form of distance/time) achieved by the drilling assembly conditioned or processed as a function of depth. Thus, due to the penetration being vertically beneath the drill head, the characteristic of the deposit is approximated is of the deposit beneath the drill head from data obtained during the drilling operation, which is contrasted with wireline measurement of the lateral side walls of the borehole after the drilling operation has occurred.

In one embodiment, the rate of penetration is initially determined or calculated from the data/information received from the network of sensors as a function of time. With this format of the rate of penetration data, continued processing converts the rate of penetration so as to be provided as a function of depth. In undertaking this conversion one or more numerical processing techniques may be employed. Any of the following processing techniques may be employed: spline approximations of any appropriate order (for example, linear, non-linear), numerical interpolation/extrapolation, numerical filtering techniques for smoothing/conditioning of raw processed data. In undertaking any such processing of the data/information, it will be understood that care must be taken to remove drilling rod changes from the rate of penetration data/information (ie. information log). The skilled reader will be aware of what other techniques may be employed for processing purposes in the context of the principles described herein.

In one embodiment, with the rate of penetration of the drilling assembly processed/established as a function of depth, such data can then be used in accordance with the predetermined relationship characteristic of or unique to the drilling assembly for providing an approximation of the characteristic of the deposit. Because the relationship characteristics are unique to the drilling assembly each drilling assembly will potentially have a different set of relationship characteristics.

In one embodiment, the predetermined relationship characteristic of or unique to the drilling assembly is provided in the form Y=Mx+C, where M and C are coefficients unique to the drilling assembly employed in the drilling operation, Y is the approximation of the characteristic of the deposit of interest, and x may be substituted for the rate of penetration data processed/established as a function of depth. Thus, each drilling assembly may have its own unique coefficients.

It will be appreciated that the linear form of the predetermined relationship characteristic of or unique to the drilling assembly is a simple relationship. It is, however, envisaged that a more practical form is likely to involve a multi-parametric, non-linear relationship. Thus, in other embodiments, the predetermined relationship characteristic of or unique to the drilling assembly can be of non-linear form and is not needed to be limited to a (simple) linear form.

In one embodiment, the characteristic of the deposit of interest is the bulk density of the deposit.

In one embodiment, the predetermined relationship characteristic of the drilling assembly is determined by way of the processor module configured operable for receiving data/information derived from the network of sensors and processing the data/information so as to provide:
a set of data representative of incursion into the deposit achieved by way of the drilling assembly as a function of depth, and
a further set of data representative of a geophysical property as a function of depth,

the processor module further configured for processing the sets of data to generate a representation of a correlation between both sets of data.

In one embodiment, the representation of a correlation between both sets of data is achieved by way of a mathematical or statistical regression technique.

In one embodiment, the form of the representation is linear, but could be of higher order if appropriate.

In one embodiment, the nature of the relationship characteristic of the drilling assembly is linear, and of the form: Y=Mx+C, whereby, Y represents the approximation of the characteristic of the deposit; M and C represent gradient and offset coefficients/values of said form; and x represents one or more parameters representative of the incursion (such as for example, in one embodiment, the rate of penetration of the deposit achieved by the relevant drilling assembly).

In one embodiment, the relationship characteristic of the drilling assembly may be informed by data/information relating to one or more boreholes drilled using the same drilling assembly.

In one embodiment, improved accuracy or refinement of the predetermined relationship characteristic of the drilling assembly is by way of assessment or processing of data/information relating to more than one boreholes drilled using the same drilling assembly.

In one embodiment, the network of sensors comprises a plurality of sensors or sensor modules each configured for obtaining, such as by measuring, monitoring, recording, and/or logging of a respective parameter related to the drilling assembly. In one embodiment, said obtaining occurs while the drilling assembly is operating/drilling.

In one embodiment, one or more of the sensors or sensor modules are configured to measure respective parameters of the surface assembly. In one embodiment, one or more of the sensors or sensor modules are configured to measure respective parameters of the downhole assembly.

In one embodiment, the drilling assembly comprises a drilling device. In one embodiment, the drilling device is one suitable for operable use in a reverse circulation drilling operation. In one embodiment, the drilling device is or comprises a hammer drill, being operable for use in a reverse circulation drilling operation. The method of the present invention is particularly effective for reverse circulation drilling operations using a reverse circulation drilling device.

In one embodiment, the processor module is configured operable for receiving, monitoring, sampling, recording, logging, processing any of the following data/information relating to any operational parameter of the drilling assembly, while drilling or otherwise.

In one embodiment, the processor module is configured operable via the network of sensors for receiving, monitoring, sampling, recording, logging, processing any of the following data/information: bit depth—this being displacement along the drilled borehole of the drill bit (for example, further/deeper into the borehole may be indicative of a positive value); drill string state—whether the drill string is clamped or free to move; rate of penetration—the velocity of the drill bit along the borehole (for example, movement into the target borehole may be a positive value); penetration per revolution—the penetration distance of the drill bit for each revolution; borehole depth—the length of the drilled borehole.

In one embodiment, the processor module is configured operable via the network of sensors for receiving, monitoring, sampling, recording, logging, processing data information in respect of the drill head of the drilling device, such data/information comprising any of the following parameters: position of the drill head—the displacement of the drill head from the bottom of the mast (for example, upwards of the mast may be a positive value); velocity for the drill head—the velocity of the drill head along the mast (movement up the mast is positive).

In one embodiment, the processor module is configured operable via the network of sensors for receiving, monitoring, sampling, recording, logging, processing data/information in respect of the rotation of the drill head, such data/information comprising any of the following parameters: angular position of the drill head—the absolute (or could relative to a target reference position) angular position of the drill head; rate of rotation of the drill head—the rotation rate of the drill head; drill head torque—the torque applied by the drill head.

In one embodiment, the processor module is configured operable via the network of sensors for receiving, monitoring, sampling, recording, logging, processing data/information in respect of events/changes occurring in respect of drilling rods or drilling segments used in the drilling operation, such data/information comprising any of the following parameters: actions/events involving one or more of the drilling rods or segments—for example, actions/events such as whether the drill rod/segment was removed or inserted into to the drill string; length—for example, the length of the rod/segment that may be subject to a removal or insertion event, or which relates to an action/event related to the drilling operation; time—for example, the time taken to undertake a drill rod/segment insertion or removal action/event; index—the index of the rod subject to an insertion/removal action/event—for example, the index may be arranged so as to count upwards for inserted rods, and downwards for removed rods; weight on string—force exerted onto the drill string at the surface end of the operation (for example, force towards the drilled borehole may be a positive value (or could be negative)); string weight—the weight of the components in the drill string; mast angle—the angle of the mast when reference to vertical (for example, vertical being aligned with the direction of gravity); estimated true depth—the vertical depth of the drill bit in the borehole (for example, positive may be in the direction of gravity).

Having regard to the information described above, it will be understood that any of such information can be used to generate a measure of the depth of the bit and/or to generate an understanding of the context of the drilling operation being undertaken (which often contributes to determining the measure of the bit depth). For example, in some instances, drill rods are inadvertently mishandled (such as being dropped in the borehole) and therefore awareness of such information assists in the determination of the bit depth.

In one embodiment, the processor module is configured operable via the network of sensors for receiving, monitoring, sampling, recording, logging, processing data/information in respect of the location of the drilling rig, such data/information comprising any of the following parameters: latitude—the latitude of the global positioning system (GPS) antenna on the rig; longitude—the longitude of the GPS antenna on the rig; altitude—the height of the GPS antenna on the rig with respect to the GPS reference ellipsoid (ie. a mathematically defined surface that approximates the truer figure of the Earth).

In one embodiment, the processor module is configured operable via the network of sensors for receiving (for example, via the network of sensors), monitoring, sampling, recording, logging, processing data/information in respect of the velocity of the drilling rig such data/information comprising any of the following parameters: heading—the direction, from true north, that the rig is heading; horizontal velocity—the horizontal speed of the rig; vertical velocity—the vertical velocity of the rig (for example, positive indicates an increase in altitude). As a general comment, this information is used to assist in the determination of the identity of boreholes which have been drilled by the drilling assembly. In one sense, the progressive drilling log (PLOD) data/information is used to identity a borehole which is then matched against the known movements of the drilling assembly.

In one embodiment, the system may be configured operable via the network of sensors so as to allow the processor module for receiving, monitoring, sampling, recording, logging, processing data information relating to any operational parameter of the drilling assembly—either before, during, or following the drilling operation.

In one embodiment, the network of sensors is substantially provided in the form of technology marketed as “drillHUB”.

In one embodiment, embodiments of the system described herein are configured operable with an embodiment or implementation of the drillHUB technology for, at least in part, receiving, monitoring, sampling, recording, logging, processing data/information relating to the measuring of a number of parameters relating to the operation of the drilling assembly, and processing same so as to provide the first and second sets of data.

In one embodiment, the processor module is provided in the form of or part of a computing device. In one form, the processor module is provided in the form of a single board computing device, such as for example, a Raspberry Pi 3 Model B+. The skilled reader would be aware of other suitable computing devices that could be used to implement the principles described herein.

In one embodiment, the processor module is configured so as to perform or otherwise enable any of the methods, processes, events, or activities described herein.

In one embodiment, raw sensor data is made available by way of the network of sensors (for example, by way of the drillHUB technology) is collected.

In one embodiment, once collected, data/information relating to a head position (for example, the displacement of the drill head from the bottom of the mast) and a float position of the spindle is determined (which may be for example, by way of an appropriate calculation).

In one embodiment, the data/information is processed in a manner allowing a calculation to be made of the relative position of the drill head spindle.

In one embodiment, processing is undertaken so as to determine a magnitude of a physical offset existing between the head position and a selected ground reference level.

In one embodiment, the offset is then used to calculate a bit depth reference value.

In one embodiment, a calculation is then made of a length of the rod segment length. Such a calculation may include adding the length of any newly added rod segment to the prior determined or current offset value.

In one embodiment, a calculation is made of the continuous bit depth. Such a calculation may include or be informed by interrogation/use of predetermined or known offset data relevant to the operation (for example, using a known or predetermined table of offsets per rod addition).

In one embodiment, once the continuous bit depth is calculated, a calculation is made of the rate of penetration achieved by the drilling assembly as a function of depth. In one embodiment, such a calculation may involve, in one form, a spline-based interpolation technique(s) to achieve a uniform sample rate across the extent of the data/information.

In one embodiment, a geophysical property measured or identified by way of the drilling operation and rationalised as a function of depth. In one embodiment, wireline logs generated separately from the drilling operation which comprise geophysical measurements (for example, back scattered gamma radiation measurements) are scrutinised/interrogated. The wireline log information may be processed with the view to removing any anomalous data (for example, data that correlates to sections of the drilled borehole that are considered of poor quality and inappropriate for inclusion in the analysis). This process results generally in the conditioned geophysical data being a function of depth.

In one embodiment, once the wireline data (ie. geophysical data as a function of depth) has been prepared, the data is correlated with the depth-based rate of penetration data. In one embodiment, the correlation involves a mathematical/statistical regression. In one embodiment, such regression is linear. In one form, the regression results in the generation of a coefficients used to describe a linear expression/equation of the form Y=Mx+C. With the (linear) relationship determined for the relevant drilling assembly/rig, an approximate/synthetic representation of the bulk density of a deposit drilled with the relevant drilling assembly/rig can be obtained.

In one embodiment, the process of rationalising/converting the rate of the penetration of the drilling assembly from a time-based measure to one as a function of depth, may include the following:

identifying a value relating to a maximum bit depth, and setting this value zero,

initializing an array for receiving a sequence of rate of penetration data prepared as a function of depth,

generating a sequence of data comprising times and the obtained (such as by, for example, measuring, recording, or logging) bit depth corresponding to respective times,

generating a sequence of data comprising time and the obtained (such as by measuring, recording, or logging) rate of penetration data corresponding to respective times,

for each data instance in the time-based rate of penetration sequence of data:
determine the bit depth corresponding to the relevant or selected time (determination of the bit depth may involve, for example, use of interpolation/extrapolation techniques as required—for example, in instances where no time/bit depth data matches the selected point in time),
if the calculated/determined bit depth is found to be greater than the current maximum bit depth, add new data (for example, add a new bit depth, rate of penetration data pair) reflecting same to the existing data sequence, and update the current maximum bit depth value to equate with the newly calculated bit depth.

Once all data in the time-based rate of penetration sequence of data have been iterated through, the resulting data is a representation of the rate of penetration of the drilling assembly rationalised as a function of depth.

In one embodiment, wireline density data obtained from wirelines logs generated by wireline measuring of back scatter gamma radiation of the borehole separately from the drilling operation are filtered or appropriately conditioned to remove data considered to be of poor quality.

In one embodiment, the rate of penetration data is filtered to ensure that no rod change events are included (for example, the applied filtering process can be set using a criterion of 0<rate of penetration<5; whereby the upper bound of the tested range is set so as to remove rod pulls from the resulting data).

In one embodiment, the wireline density and rate of penetration data are processed as appropriate using any relevant/appropriate interpolation and/or filtering techniques to smooth out any obvious/prejudicial anomalous data (for example, noise spikes).

In one embodiment, the wireline density and rate of penetration data, with any anomalous data (for example, noise spikes) removed, is processed so as to match or correlate the two sets of data by depth.

In one embodiment, with both sets of data matched or correlated by depth, the wireline density data is matched or correlated with the rate of penetration data. Once in this format, a linear regression is applied using appropriate software, so as to determine the coefficient(s) (or offset values) used to describe the equation premising the regression analysis. In one embodiment, the coefficients settled and converged as required (or considered acceptable), the relationship is arranged in a generic linear equation of the form Y=Mx+C. Once formed, this relationship is now usable in solving for the approximate/synthetic density using depth-based rate of penetration data when available from a subsequent drilling operation using, of course, the drilling rig to which the now established relationship relates.

In one embodiment, rate of penetration and wireline log data sequences from multiple borehole operations can be used to check or test for statistical relevance, eg. using R²>0.6.

In one embodiment, if additional data is required to refine the coefficients/offset values, the above steps can be repeated on data sourced from multiple boreholes to improve the convergence of the generated regression coefficients.

According to a second principal aspect, there is provided a system for determining an approximation or estimation of a geophysical property of a deposit subject to a drilling operation by way of a drilling assembly, the system comprising:

a processor module arranged in operable association with a network of sensors operable for measuring a number of parameters relating to the operation of the drilling assembly, the processor module configured operable for receiving data/information derived from the network of sensors and processing the data/information so as to provide:
a set of data representative of incursion into the deposit achieved by way of the drilling assembly as a function of depth, and
a further set of data representative of a measured or identified geophysical property of the deposit as a function of depth,

the processor module further configured for processing the sets of data to generate a representation of a correlation between both sets of data.

In one embodiment, the representation of a correlation between both sets of data is achieved by way of a mathematical or statistical regression technique.

In one embodiment, the form of the representation is linear, but could be of higher order if appropriate.

In one embodiment, use of the present system serves as a calibration process for a drilling assembly.

According to a third principal aspect, there is provided a method for use in determining or providing an approximation or estimation of a characteristic of a deposit subject to a drilling operation by way of a drilling assembly, the method comprising:

receiving, by a processor module, data/information derived from a network of sensors operable for measuring a number of parameters relating to the operation of the drilling assembly,

processing, by the processor module, the data/information so as to provide a representation of incursion into the deposit achieved by way of the drilling operation rationalised as a function of depth,

processing, by the processor module, said representation in accordance with a predetermined relationship characteristic of or unique to the drilling assembly for providing an approximation or estimation of the characteristic of the deposit as a function of one or more parameters representative of the incursion.

According to a fourth principal aspect, there is provided a method for determining an approximation or estimation of a geophysical property of a deposit subject to a drilling operation by way of a drilling assembly, the method comprising:

receiving, by a processor module, data/information derived from a network of sensors operable for measuring a number of parameters relating to the operation of the drilling assembly,

processing, by the processor module, the data/information so as to provide:
a set of data representative of incursion into the deposit achieved by way of the drilling assembly as a function of depth, and
a further set of data representative of a measured or identified geophysical property of the deposit as a function of depth,

processing, by the processor module, the sets of data to generate a representation of a correlation between both sets of data.

In one embodiment, the method serves as a calibration process for the drilling assembly.

In one embodiment, the method comprises sourcing data/information from one or more boreholes drilled using the (same) drilling assembly. Preferably, data from each of the representations of incursion and the measured or identified geophysical property of the deposit of each borehole. In this manner, improved accuracy or refinement of the relationship characteristic of the drilling assembly is by way of assessment or processing of data/information relating to more than one boreholes drilled using the same drilling assembly.

In one embodiment, the method comprises configuring the processor module so as to be in operable association (for example, by way of any appropriate signal communications means) with the network of sensors in a manner so that the data/information can be received by the processor module such that the processing can be carried out.

In one embodiment, the network of sensors operable with the method of present principal aspect may be any of those described above in relation to the first principal aspect, or as described herein.

In one embodiment, the sensors operable with the method of present principal aspect may be any of those described above in relation to the first principal aspect, or as otherwise described herein.

According to a fifth principal aspect, there is provided a system for use in providing an approximation or estimation of a density of a deposit subject to a drilling operation by way of a drilling assembly, the system comprising:

a processor module configured operable for receiving data/information derived from a network of sensors operable for measuring a number of parameters relating to the operation of the drilling assembly, and processing the data/information so as to provide a rate of penetration into the deposit achieved by way of the drilling assembly as a function of depth,

the processor module further configured for processing the rate of penetration data in accordance with a predetermined relationship characteristic of or unique to the drilling assembly for providing an approximation or estimation of the density of the deposit.

According to a sixth principal aspect, there is provided a method for use in determining or providing an approximation or estimation of a density of a deposit subject to a drilling operation by way of a drilling assembly, the method comprising:

receiving, by a processor module, data/information derived from a network of sensors operable for measuring a number of parameters relating to the operation of the drilling assembly,

processing, by the processor module, the data/information so as to provide a rate of penetration into the deposit achieved by way of the drilling operation as a function of depth,

processing, by the processor module, the rate of penetration in accordance with a predetermined relationship characteristic of or unique to the drilling assembly for providing an approximation or estimation of the density of the deposit.

According to a seventh principal aspect, there is provided a system for determining an approximation or estimation of a geophysical property of a deposit subject to a drilling operation by way of a drilling assembly, the system comprising:

a processor module arranged in operable association with a network of sensors operable for measuring a number of parameters relating to the operation of the drilling assembly, the processor module configured operable for receiving data/information derived from the network of sensors and processing the data/information so as to provide:
a set of data representative of a rate of penetration into the deposit achieved by way of the drilling assembly as a function of depth, and
a further set of data representative of a geophysical property measured or identified by way of the drilling operation as a function of depth,

the processor module further configured for processing the sets of data to generate a representation of a correlation between both sets of data.

According to an eighth principal aspect, there is provided a method for determining an approximation or estimation of a geophysical property of a deposit subject to a drilling operation by way of a drilling assembly, the method comprising:

receiving, by a processor module, data/information derived from a network of sensors operable for measuring a number of parameters relating to the operation of the drilling assembly,

processing, by the processor module, the data/information so as to provide:
a set of data representative of a rate of penetration into the deposit achieved by way of the drilling assembly as a function of depth, and
a further set of data representative of a geophysical property measured or identified by way of the drilling operation as a function of depth,

processing, by the processor module, the sets of data to generate a representation of a correlation between both sets of data.

According to a ninth principal aspect, there is provided a drilling operation or system configured so as to operate or enable, whether in part or otherwise, any embodiment of a system or method as described herein. In one embodiment, the drilling operation is any of the following: a reverse circulation drilling operation, a rotary air blast drilling operation, an air core drilling operation, a mud rotary drilling operation, a diamond rotary drilling operation. It will be appreciated that the principles described herein are not to be limited to any specific drilling method but could be modified or varied as appropriate for use with any type of drilling operation.

According to a tenth principal aspect, there is provided a reverse circulation drilling operation or system configured so as to operate or enable, whether in part or otherwise, any embodiment of a system or method as described herein.

Various principal aspects described herein can be practiced alone or combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples or embodiments.

For the purposes of summarising the principal aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

### BRIEF DESCRIPTION OF THE DRAWINGS

Further features of the inventive principles are more fully described in the following description of several non-limiting embodiments thereof. This description is included solely for the purposes of exemplifying the inventive principles. It should not be understood as a restriction on the broad summary, disclosure or description as set out above. The description will be made with reference to the accompanying drawings in which:

FIG. 1 shows a schematic view of one embodiment of a reverse circulation drilling rig operable with one embodiment of the system disclosed herein;

FIG. 2 shows schematic view of one embodiment of a downhole assembly operable with the embodiment of the drilling rig shown in FIG. 1;

FIG. 3 shows a flow diagram of one embodiment of a method operable in accordance with one embodiment of the system disclosed herein;

FIG. 4 shows a flow diagram of another embodiment of a method operable in accordance with another embodiment of the system disclosed herein;

FIG. 5 shows a flow diagram of a further embodiment of a method operable in accordance with another embodiment of the system disclosed herein;

FIG. 6 shows one embodiment of a process used for converting rate of penetration data (data sourced from drilling operation) from time based to depth based;

FIG. 7 shows one embodiment of a process for performing a linear regression between the wireline density data/information and depth-based rate or penetration data from a sourced from a drilling operation;

FIG. 8 shows example data/information plots taken from wireline logs (W_{L}), drillHUB (D_{H}) and drillMax (D_{M}) technologies, and resulting approximation or ‘synthetic’ calculations (S_{L}) and wireline log data; and

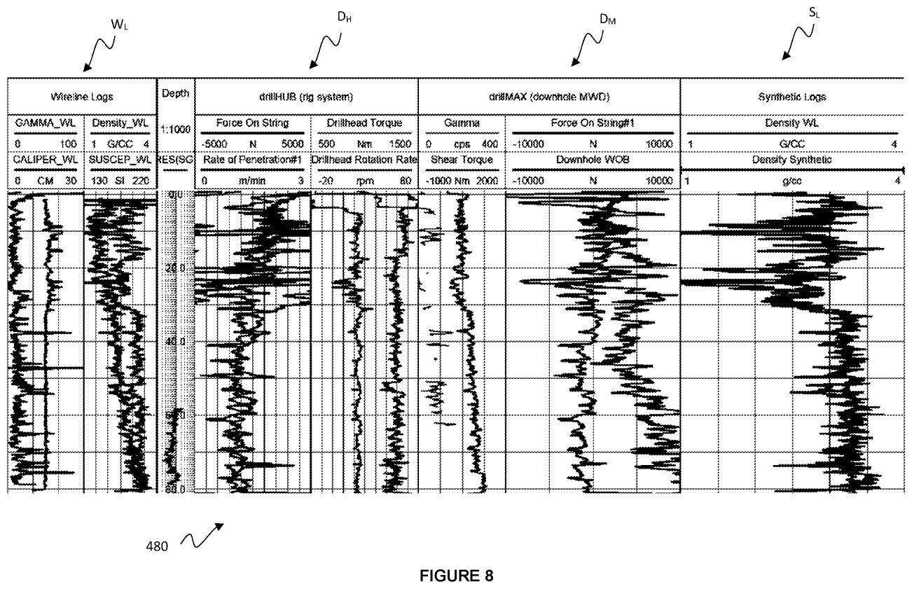

FIG. 9 shows an example plot of density versus rate of penetration (as a function of depth) showing the result of a linear regression overlayed.

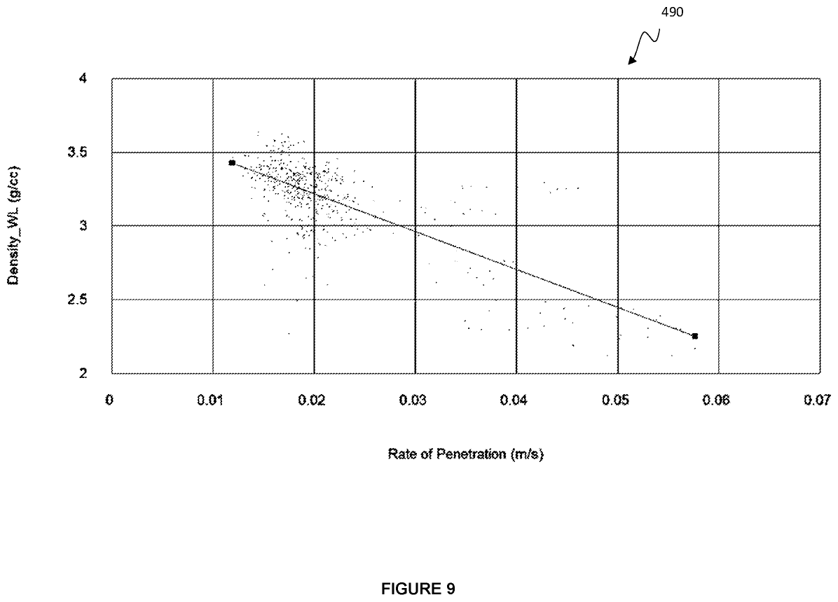

In the figures, like elements are referred to by like numerals throughout the views provided. The skilled reader will appreciate that elements in the figures are illustrated for simplicity and clarity and have not necessarily been drawn to scale. For example, the dimensions and/or relative positioning of some of the elements in the figures may be exaggerated relative to other elements to facilitate an understanding of the various embodiments exemplifying the principles described herein. Also, common but well understood elements that are useful or necessary in a commercially feasible embodiment are often not depicted in order to provide a less obstructed view of these various embodiments. It will also be understood that the terms and expressions used herein adopt the ordinary meaning as is accorded to such terms and expressions with respect to their corresponding respective areas of inquiry and study except where specific meanings have otherwise been set forth herein.

It should be noted that the figures are schematic only and the location and disposition of the components can vary according to the particular arrangements of the embodiment(s) as well as of the particular applications of such embodiment(s).

Specifically, reference to positional descriptions, such as ‘lower’ and ‘upper’, and associated forms such as ‘uppermost’ and ‘lowermost’, are to be taken in context of the embodiments shown in the figures, and are not to be taken as limiting the scope of the principles described herein to the literal interpretation of the term, but rather as would be understood by the skilled reader.

Embodiments described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description and apply throughout. Unless otherwise defined, all other scientific and technical terms used herein have the same meaning as commonly understood to one of ordinary skill in the art to which the embodiment(s) relate.

### DETAILED DESCRIPTION

The words used in the specification are words of description rather than limitation, and it is to be understood that various changes may be made without departing from the spirit and scope of any aspect of the invention. Those skilled in the art will readily appreciate that a wide variety of modifications, alterations, and combinations can be made with respect to the above described embodiments without departing from the spirit and scope of any aspect of the invention, and that such modifications, alterations, and combinations are to be viewed as falling within the ambit of the inventive concept.

Throughout the specification and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

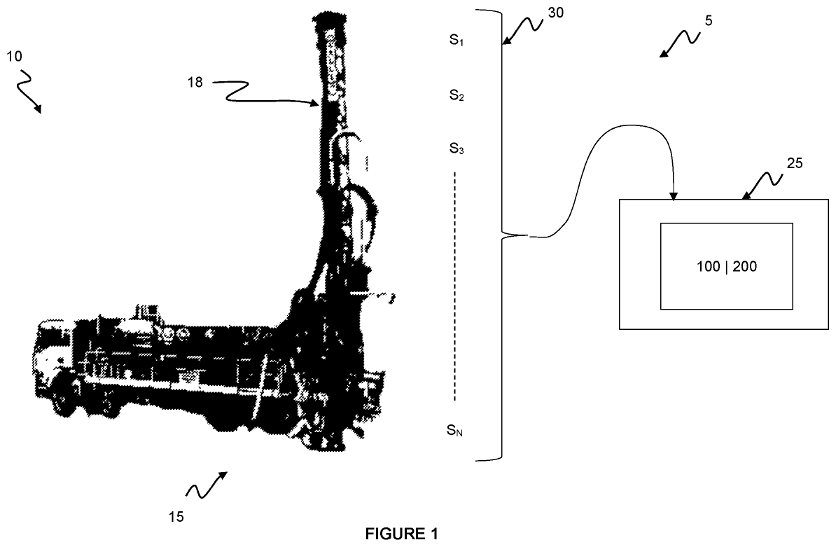

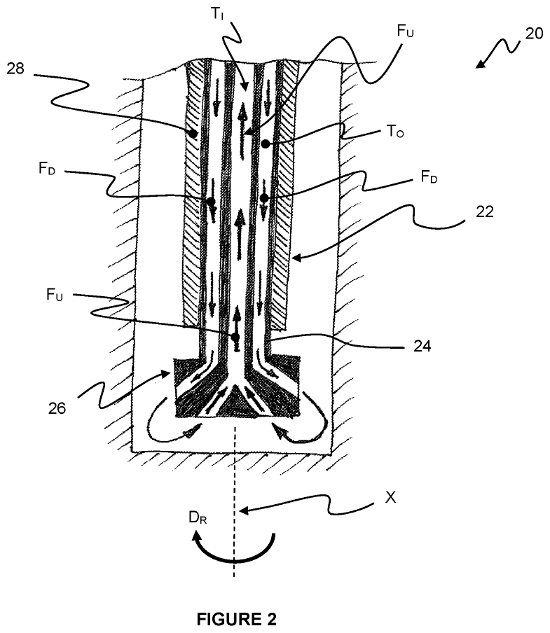

In one embodiment, the principles described herein are used in the context of a reverse circulation drilling operation typically used in exploratory operations in the mining sector. As compared other forms of drilling, RC drilling is generally slower and costlier but achieves better penetration than, for example, rotary air blast (RAB) or air core drilling (ACD); RC drilling is cheaper than diamond coring and is thus preferred for most mineral exploration work. By way of brief explanation, and with reference to FIG. 2, reverse circulation (RC) drilling generally use drilling rods (shown in FIG. 2 as feature 28) having inner T_{I} and outer T_{O} tubes, whereby the drill cuttings are returned to the surface inside the rods—via inner tube T_{I}. The drilling mechanism usually includes a pneumatic reciprocating piston (known as a hammer drill—shown in FIG. 2 as feature 24) configured for driving a generally tungsten-steel drill bit (shown in FIG. 2 as feature 26). In general, RC drilling utilises much larger rigs (a standard drilling rig is shown in FIG. 1 as feature 18) and machinery and are usually capable of drilling to depths of up to 500 metres. RC drilling ideally produces dry rock chips (the skilled reader would understand that water may be added to the air flows thereby wetting out the chips), as large air compressors dry the rock out ahead of the advancing drill bit (26).

RC is achieved by blowing air down (shown as Fu in FIG. 2) the outer tube T_{O} of the rod, the differential pressure creating air lift off the water and cuttings up the inner tube T_{I} inside each rod (28). It reaches the deflector box at the top of the drill string then moves through a sample hose which is attached to the top of the cyclone. The drill cuttings travel around the inside of the cyclone until they fall through an opening at the bottom and are collected in a sample bag. For any drilled borehole there will be a large number of sample bags, each one marked to record the location and drilling depth that the sample was obtained. The collected series of sample bag cuttings are later taken for analysis to determine the mineral composition of the drilled borehole. The analysis results of each individual bag represents the mineral composition at a particular sample point in the drilled borehole. Geologists can then survey the drilled ground analysis and make decisions about the value of the overall mineral deposit.

Furthermore, the remoteness of many mine sites exposes personnel to elevated safety risks when traveling to these sites. The mining industry at large is thus actively pursuing development and implementation of advanced sensing technologies and ‘Big Data’ ecosystems to gain a deeper understanding of their assets. Accordingly, there exists strong motivation for mining service companies to work towards adopting a ‘plug-and-play’ LWD technology that can be deployed by RC drilling rig crews. Eliminating the need for separate wireline logging runs and associated service personnel further reduces in-field headcount, with direct effect on costs, improved safety and reduced environmental impact.

Measurement While Drilling (MWD) and Logging While Drilling (LWD) systems are commonplace in the oil and gas (O&G) industry. MWD systems measure drilling specific parameters (shock and vibration), direction (inclination and azimuth) and parameters related to drilling performance. LWD are more complex systems which can transmit to the surface essential petrophysical, geophysical and geochemical data in real-time. Rig based sensors provide information on the drilling performance of the rig itself. This can include basic measurements such as, for example, air flow, water flow, hydraulic measurements, drill-head location, mast inclination, rate of penetration, weight on string, and other parameters that can be directly measured on the rig itself.

However, inconveniently, at present, after each new borehole has been drilled, an inclination and azimuth survey tool is deployed on a wireline to log borehole trajectory. One or more additional wireline runs are then performed to log various geophysical properties. The possibility of acquiring all these measurements while drilling the boreholes would serve to assist in eliminating the need for subsequent wireline runs and associated costs. Real-time monitoring and analysis of data could also guide optimisation of RC drilling parameters, thereby reducing rig time (which are generally hired) and associated cost. Ultimately, LWD system's have the potential to be able to replace a large portion of the assay work that is conducted on drilling rock cuttings. The principles described herein seek to provide at least one solution to assist in working towards this overarching aim.

FIGS. 1 and 2 show of one embodiment a system 5 for use in providing an approximation or estimation of a characteristic (for example, a measure of the bulk density) of a deposit subject to a drilling operation by way of a drilling assembly 10. As shown in FIGS. 1/2, the drilling assembly 10 comprises operable surface assembly 15 (provided in the form of a drill rig 18) and downhole assemblies 20 (provided in the form of a drilling apparatus 22). In the form shown in FIG. 1, the system 5 comprises a processor module 25 arranged in operable association with a network of sensors 30 operable for measuring a number of parameters relating to the operation of the drilling assembly 10. Broadly, as described herein, the processor module 25 is operable for receiving data/information via the network of sensors 30 and processing this data/information in accordance with the substance of the embodiments of methods 100, 200 outlined below.

As the skilled reader will appreciate, in the assessment of a value of a deposit it is usual to determine and consider measures of the density of the deposit. A number of density measures can be considered such as for example, dry bulk density, insitu bulk density, and specific gravity density. Observations involving dry bulk density and specific gravity often involve methods being labour intensive in nature which can lead to lower sample rates and, consequently, less than desirable density data. In contrast, geophysical borehole logging for density is a commonly used practice for at least its more precise technique which often leads to the generation of a large dataset of information for modelling purposes. Generally speaking, geophysical borehole density logging is a rapid, precise and cost-effective method of generating an extensive segment of bulk density data/information. In many forms, geophysical borehole density logging utilizes laterally (relative to the length of the borehole) back scattered gamma radiation from a small radioactive source within the geophysical probe. Quality control of the density measurements can be achieved by using caliper data (from the same probe) to identify zones of enlargements or washouts where measurements may be compromised. Dry density values can be generated from geophysical density data set with knowledge of the water filled porosity.

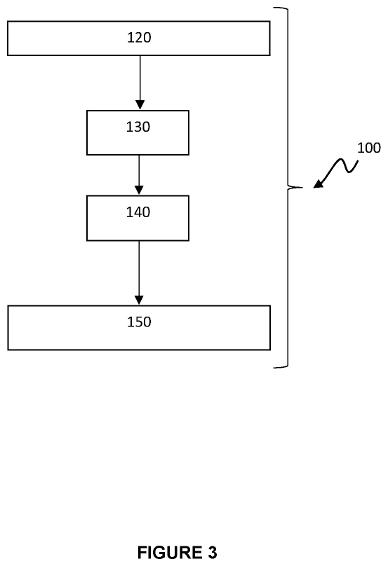

One embodiment of a method 100 operable by way of the system 5 for use in determining or providing an approximation or estimation of, for example, the bulk density of a deposit subject to a drilling operation by way of a drilling assembly 10 is shown in FIG. 3. Method 100 involves the processor module 25 receiving data/information (at 120) derived from the network of sensors 30. The data/information obtained from the network of sensors 30 is processed (130) by the processor module 25 so as to provide a representation of the incursion (which includes, for example, the rate of penetration into the deposit substantially beneath the drill head) achieved by the drilling assembly 10 as a function of depth. Further processing (140) is conducted by the processor module 25 using the data/information representative of the incursion with a predetermined relationship characteristic of, or unique to, the drilling assembly 10. Using the predetermined relationship characteristic of the drilling assembly 10, processing 140 serves to allow an approximation or estimation of the bulk density of the deposit to be found or computed as a function of one or more parameters representative of the incursion, such as for example, the determined/computed depth based rate of penetration achieved by the drilling assembly (whether this be in-situ in real-time during a drilling operation, or following completion of the drilling operation). Operation of the system 5, method 100 seeks to avoid the need for subsequent (and specific) wireline runs down the borehole once it is drilled. Instead, a relationship indicative of the bulk density of the deposit being drilled/explored can be approximated based using the predetermined relationship unique to the drilling assembly 10 while the borehole is being drilled. In this manner, significant savings in operational time (and associated cost) have the potential to be realized by avoiding subsequent wireline logging operation being conducted.

In accordance with the principles described herein, the approximation or estimation (which could be referred to as a ‘synthetic’ density value) is premised upon a relationship (in one form, for example, a mathematical expression or equation) being determined that is specific to the drilling assembly 10 being used in the drilling operation. Thus, consistent with the principles described herein, before any approximation/estimation of the density of a prospective deposit can be made, the drilling rig to be used in the drilling/exploratory process needs to be the subject of a ‘calibration’ exercise that seeks to measure key parameters that define a relationship between a geophysical property of interest (for example, back scattered gamma radiation) and physical parameters of a drilling operation conducted by the drilling assembly 10. For the embodiments described herein, the nature of the relationship characteristic of the drilling assembly is linear, and of the form: Y=Mx+C, where, Y represents the approximation/estimation of the characteristic of interest (eg. bulk density) of the deposit; M and C represent gradient and offset coefficients/values of the linear form; and x represents the variable parameter; this being in one embodiment, the rate of penetration of the deposit achieved by the relevant drilling assembly 10.

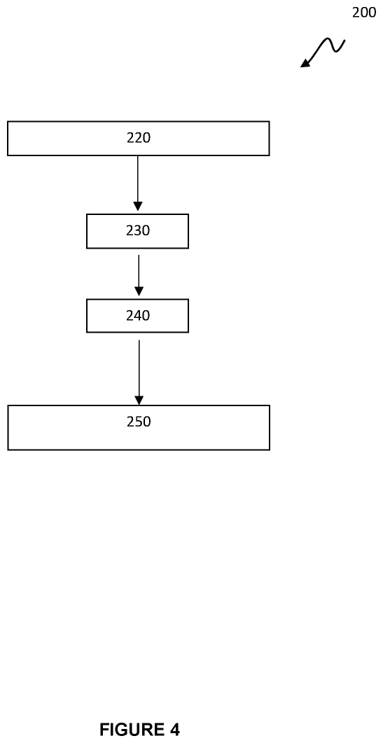

Thus, the determination of the relationship characteristic of the drilling assembly 10 could be seen as being part of a calibration process undertaken so as to determine the required parameters of the relationship (for example, the coefficients and offset components of the relationship as noted above) which operate to remain constant and unique for the relevant drilling assembly 10 for at least a practically useful period of time before possibly being recalibrated. It is to be understood that such components may change between drilling assemblies and therefore may need to be determined for each drilling rig. One embodiment of such a method (200) is shown in flow diagram form in FIG. 4.

With brief reference to FIG. 1, the network of sensors 30 comprises a number of sensor modules (denoted as features S₁, S₂, S₃, through S_{N}, in FIG. 1). The network of sensors 30 is provided generally physically with the operable surface assembly 15 for measuring a number of physical responses relating to the operation of equipment of both the drill rig 18 and drilling apparatus 22. In the form shown, the sensor network 30 is part of the drillHUB technology developed by the present Applicant and associated with the drill rig 18. In brief, drillHUB is a rig-based system that collates data from a local sensor network and associated downhole tool (for example, the MWD based drillMAX tool also developed and operated by the present Applicant). The drillHUB technology is sensor-agnostic and may be integrated into existing instrumented rigs.

In one implementation of operation, measurements collated by the drillHUB technology are automatically and securely streamed to a cloud-based data management tool (for example, the drillINFO management tool developed by the present Applicant) where the collected data can be analysed and stored. Computing techniques are used to calculate driller relevant operational metrics to provide feedback to the drillers based at the drill rig. In the embodiment of the system 5 (and related methods) described herein, the drillHUB technology is employed as a way of availing of the sensor network that is inherent in that technology for the purposes of leveraging the advantages of the principles described herein.

The sensor network 30 may comprise a broad range of sensors. For the case where the system 5 is operable with the drillHUB technology, the sensor network 30 is configured operable for providing any of the following parameters:
bit depth—this being displacement along the drilled borehole of the drill bit (for example, further/deeper into the borehole may be indicative of a positive value);
drill string state—whether the drill string is clamped or free to move;
rate of penetration—the velocity of the drill bit along the borehole (for example, movement into the target borehole may be a positive value);
penetration per revolution—the penetration distance of the drill bit for each revolution;
hole depth—the length of the drilled borehole.

Data information in respect of the drill head:
position of the drill head—the displacement of the drill head from the bottom of the mast (for example, upwards of the mast may be a positive value);
velocity for the drill head—the velocity of the drill head along the mast (movement up the mast is positive).

Data/information in respect of the rotation of the drill head:
angular position of the drill head—the absolute (or could relative to a target reference position) angular position of the drill head;
rate of rotation of the drill head—the rotation rate of the drill head; drill head torque—the torque applied by the drill head.

Data/information in respect of events/changes occurring in respect of drilling rods or drilling segments:
actions/events involving one or more of the drilling rods or segments—for example, actions/events such as whether the drill rod/segment was removed or inserted into to the drill string;
length—for example, the length of the rod/segment that may be subject to a removal or insertion event, or which relates to an action/event related to the drilling operation;
time—for example, the time taken to undertake a drill rod/segment insertion or removal action/event;
index—the index of the rod subject to an insertion/removal action/event—for example, the index may be arranged so as to count upwards for inserted rods, and downwards for removed rods;
string rotation rate—the rotation rate of the drill string or drill rod/segment;
weight on string—force exerted onto the drill string at the surface end of the operation (for example, force towards the drilled borehole may be a positive value);
string weight—the weight of the components in the drill string;
estimated true depth—the vertical depth of the drill bit in the borehole (for example, positive may be in the direction of gravity);

Data/information in respect of the location of the drilling rig:
latitude—the latitude of the global positioning system (GPS) antenna on the rig;
longitude—the longitude of the GPS antenna on the rig;
altitude—the height of the GPS antenna on the rig with respect to the GPS reference ellipsoid, ie. a mathematically defined surface that approximates the truer figure of the Earth;

Data/information in respect of the velocity of the drilling rig:
heading—the direction, from true north, that the rig is heading; horizontal velocity—the horizontal speed of the rig;
vertical velocity—the vertical velocity of the rig (for example, positive indicates an The principles described herein operate on the assumption that the majority of the energy input into a RC hammer (24) is used to break rock via the reciprocating hammer action. It assumes that almost no cutting of the rock is achieved by the rotation (for example, direction D_{R}) of the drill rods (28) about axis X, as shown in FIG. 2. For the case of iron ore, it is considered that this assumption is most likely true, or, at the least, sufficiently valid or premise the solution/principles described herein.

With reference again to method 200 shown in FIG. 4, the method 200 involves receiving 220, by the processor module (25), data/information derived from the network of sensors (30) and processing the data/information so as to provide:
(i) a set of data 230 (incursion data) that is processed so as to be representative of the incursion achieved by the drilling assembly (10). Using the collected data/information, a calculation can be made so as to determine a measure of the rate of penetration of the drilling operation as a function of the depth drilled. In the determination of this measure, events such as a drill rod/segment removal and insertions (which are monitored during the drilling process) can be removed so as to reduce or avoid the presence (and influence) of potentially erroneous information.
(ii) a further set of data 240 representative of a measure of a geophysical property (geophysical data) of the deposit being drilled rationalised also as a function of the depth drilled by the drilling assembly 10. For example, data relating to the wireline density (recorded and tracked in a wireline density log) are interrogated and processed as appropriate to eliminate sections of data/information that might adversely influence the final data (for example, wireline density data/information relating to sections of the borehole considered to be of poor quality, are sought to be excluded from the processed data set).

Following the determination/provision of the data 230, 240, the method 200 involves the processor module (25) processing 250 the sets of data so as to generate a representation of a correlation between both sets of data that is characteristic of the drilling assembly (10). In one implementation, for example, the revised rate of penetration data (prepared as a function of the drill depth) is plotted and correlated against the revised wireline density data, also conditioned so as to be rationalised as a function of time. Once the correlation is made, a mathematical regression analysis is conducted (in one case, for example, a linear regression). In this process, for the case of a linear regression exercise, mathematical coefficients are determined to fit and apply a linear approximation/estimation to the correlated data sets. This process results in the determination of a linear equation defining the correlated sets of data that is now characteristic of the drilling assembly providing a ‘synthetic’ measure of the bulk density of the drilled deposit as a function of the rate of penetration. This ‘synthetic’ measure is then relevant (and acceptably applicable) for all boreholes drilled using the relevant drilling assembly.

Without being bound by theory and testing undertaken to date, for a sample test operation involving a 300RC Delta01 drilling rig manufactured by Wallis Drilling Pty Ltd, the following equation resulted from application of the principles described herein:

Synthetic_Density=−25.69*{ROP_drillHUB}+3.732

where:
(i) Synthetic_Density is an approximation/estimation of the bulk density of the deposit; and
(ii) ROP_drillHUB is data corresponding to the rate of penetration of the drilling assembly;
(iii) −25.69 is the gradient coefficient of the linear relationship resulting from the statistical regression analysis; and
(iv) 3.732 is the offset of the linear relationship resulting from the statistical regression analysis.

Accordingly, for any borehole drilled by way of the Wallis 300RC Delta01 drilling rig, the above equation can be used to generate an approximation/estimation (synthetic) of the bulk density of the deposit drilled using that drilling rig using the rate of penetration data obtained from the drilling operation (for example, via the network of sensors inherent of the drillHUB technology). Of course, the coefficients of the equation may differ between drilling rigs used of the same type (such as the same model from a given manufacturer) and will likely differ between different types of drilling rig used. It is envisaged that an equation of some level of accuracy may be available for a certain type of drilling rig, which could at least be used as a baseline. The equation for each individual drilling rig could then be refined from the baseline of the type of rig.

The process of determining the relationship or expression unique to the drilling assembly 10 can be developed based on an operation setup for drilling a single borehole. However, the skilled reader will appreciate that the relationship/expression can be improved statistically by using information emanating from the drilling of multiple boreholes when drilled using the same drilling rig. Accordingly, it would be expected that the relationship or expression for a given drilling rig would, when using data/information from multiple drilling operations, converge toward a more accurate solution (ie. the coefficients, offset of the expression would converge toward respective limit values). Of course, the time and cost of conducting multiple drilling operations for the purpose of calibrating the drilling rig would be informed, at least in part, on the commercial aspects of the overarching operation. For example, in some instances, the accuracy of the relationship/expression for an exploratory drilling operation of limited resources, is sufficient based on data/information from the drilling of a single borehole.

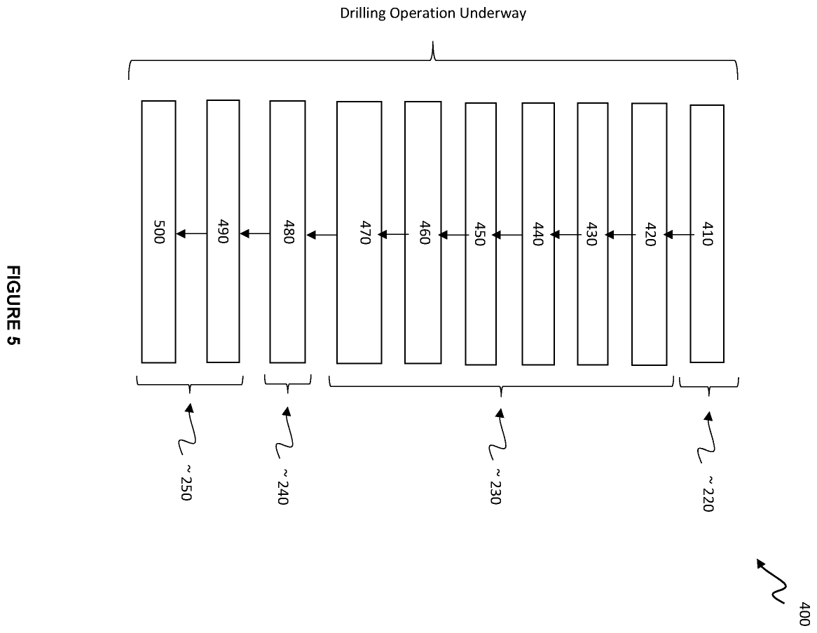

A more detailed outline (400) of the method 200 is shown in FIG. 5 and described below.

At 410, the raw sensor data made available by way of the drillHUB technology is collected. This information includes values relating to the head position (the displacement of the drill head from the bottom of the mast) and float position of the drill head spindle.

The collected data/information is processed in a manner allowing a calculation, at 420, to be made of the relative position of the drill head spindle.

At 430, further processing is undertaken so as to determine what ever physical offset exists between the head position and a selected ground reference level.

The initial offset (found at 430) is then used, at 440, to calculate a bit depth reference value.

A calculation is then made, at 450, of the rod length (total rod length), adding the length of any newly added rod segment to the prior determined or current offset value.

Using a table of listed offsets per rod segment addition, a calculation is made, at 460, of the continuous bit depth.

At 470, with the continuous bit depth computed, a calculation is now made of the rate of penetration of the drill. In the general sense and in one form, this calculation results from spline-based interpolation to achieve a uniform sample rate across the extent/scope/domain of the data.

As indicated in FIG. 5, the latter described processing correlates generally to the body of processing undertaken at 230 of the method 200 shown in FIG. 4 (and which correlates generally to the substance of the processing undertaken by method 100 at processing step 130) in the formation/compilation of the incursion data.

With the rate of penetration data conditioned as a function of the depth, at 480, the wireline logs comprising the geophysical measurements (for example, back scattered gamma radiation measurements) are scrutinised and processed with the view to removing any section comprising anomalous data (for example, data that correlates to sections of the drilled borehole that are considered inappropriate or of poor quality for inclusion in the analysis). This process (480) results generally in the conditioned geophysical data (depth based) and correlates to the processing at 240 of method 200 shown in FIG. 4.

Once the wireline data (ie. geophysical data as a function of the depth drilled) has been revised, the data is mathematically/statistically regressed with the calculated rate of penetration data (this being rationalised as a function of depth), at 490. As noted, the regression mode for the case described herein is linear. The objective of this activity is the determination of the coefficient(s) and offset that describe the linear relationship between the data sets, ie. rate of penetration data (as a function of depth), and geophysical data (as a function of depth).

Once this process of 490 is completed, at 500, the complete form of the relationship characteristic of the drilling rig can then be determined in accordance with the linear form Y=Mx+C.

Thus, with the relationship determined, method 100 may then be used to process data sourced from the relevant drill rig (conditioned to provide rate of penetration as a function of depth) to provide an approximate/synthetic representation of the bulk density of a deposit drilled with the relevant drill rig.

It will be appreciated that the linear form of the predetermined relationship characteristic of or unique to the drilling assembly is a simple relationship. It is, however, envisaged that a more practical form is likely to involve a multi-parametric, non-linear relationship (discussed briefly below). Thus, in other embodiments, the predetermined relationship characteristic of or unique to the drilling assembly can be of non-linear form and is not needed to be limited to a (simple) linear form.

While the rate of penetration as a function of depth is required in the present method, it is envisaged that the relationship characteristic of the drilling assembly could be improved upon by using the downhole weight on the bit. In this manner, the principles outlined herein can be extended to a multi-parameter, non-linear based model.

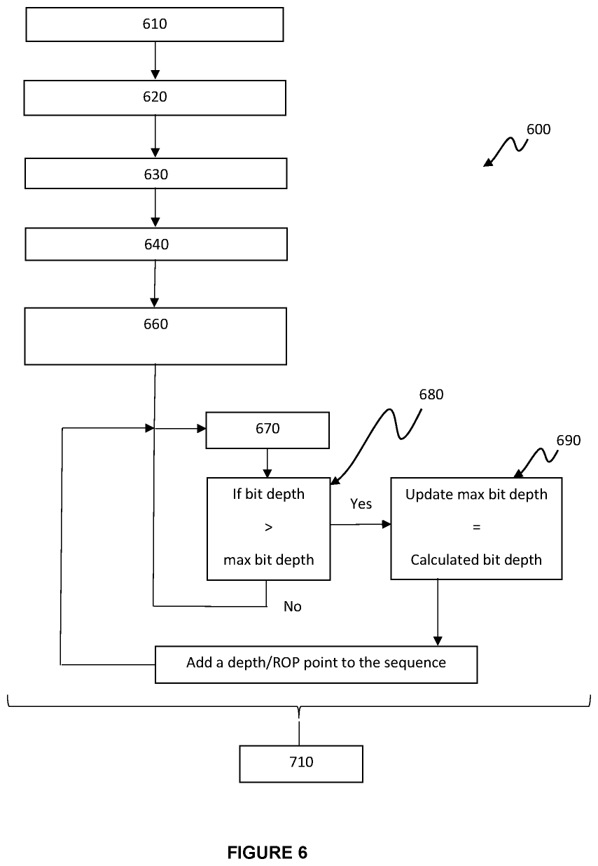

FIG. 6 shows an embodiment of a process 600 for converting the rate or penetration data from time based to depth based:

At 610, the value relating to the maximum bit depth is set to zero.

At 620, an empty sequence of depth versus rate or penetration data points is created/initialised (in an appropriate data storing array or similar).

A sequence of points consisting of times and the bit depth at those times is generated, at 630.

At 640, a sequence of points consisting of times and the rate or penetration at those times is generated.

At 660, for each data point in the established time/rate or penetration sequence, the following is undertaken.

At 670, determine the bit depth corresponding to the specified time. The bit depth can be interpolated if there is no time/bit depth point in the sequence that matches the specified time.

At 680, if the bit depth value is greater than the maximum bit depth.

If the test at 680 is affirmative, add a depth/rate or penetration point to the sequence (690).

At 700, update the current maximum bit depth value to be the recently calculated (or newly calculated) bit depth.

Once all data points in the time-based rate of penetration sequence have been iterated through, the resulting data array at 710 becomes a representation of the rate of penetration by the drilling assembly 10 as a function of depth.

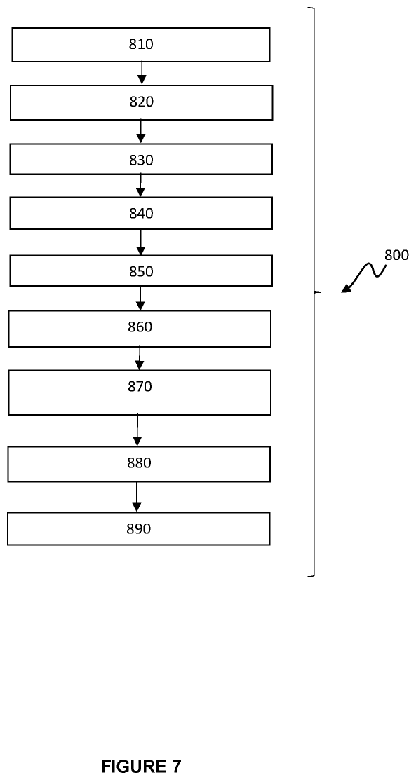

FIG. 7 shows an embodiment of a process 800 resulting in the linear regression between the wireline density data (geophysical data as a function of depth) and the depth-based rate of penetration data. Descriptions of each step in the process 800 are outlined as follows:

At 810, wireline density measurement data obtained from the wirelines logs is filtered to remove data corresponding to any perceived or assessed ‘bad’ section of the drilled borehole that may contain poor quality data (ie. quality control of the density measurements can be achieved by using caliper data (from the same probe) to identify zones of enlargements or washouts where measurements may be compromised).

At 820, the rate or penetration data is conditioned/filtered to ensure that no rod change events are included (for example, the applied filtering process can be set using a criterion of 0<{rate or penetration}<5; whereby the upper bound of the tested range is set so as to remove rod pulls from the resulting data.

At 830, the wireline density and rate or penetration data are then processed as appropriate using any relevant/appropriate interpolation and/or filtering techniques to smooth out any obvious/prejudicial noise spikes.

At 840, the wireline density and rate or penetration data, with any noise spikes removed, can be processed so as to match the two logs by depth. In undertaking this process, measured gamma ray radiation data may be used as a reference.

At 850, with both sets of data matched by way of depth, the wireline density data is plotted with the rate or penetration data. Once in this format, a linear regression is applied using appropriate software. This process determines the coefficients/offsets values used to describe the linear equation premising the regression analysis.

At 860, the coefficients/offset obtained from 850 are used to form the linear equation giving the bulk density approximation/estimation (or the ‘synthetic density’) as a function of rate of penetration.

At 870, the above step can be repeated using multiple drilled borehole operations and checked for statistical relevance, eg. using R²>0.6 (this expression being a statistical measure that represents the proportion of the variance for a dependent variable explained by an independent variable or variables in a regression model). It will be appreciated that the threshold statistical test value (0.6 in this case) is arbitrary and can be altered as required for varying degrees of statistical variance that might be required for a given use. For example, in some situations, users may require R²>0.9.

At 880, if additional data points are required to refine the coefficients/offset values, the above steps can be repeated on data sourced from multiple boreholes to improve statistics.

At 890, with the coefficients settled and converged as required (considered acceptable), the relationship is arranged in the generic linear equation form (ie. Y=Mx+C) to provide the governing (characteristic) relationship for the drilling assembly (10) in the form, Synthetic Density=[depth based rate of penetration]*Gradient+Offset. Once formed, this relationship is now usable in solving for the approximate/synthetic density using depth-based rate of penetration data when available from a subsequent drilling operation using, of course, the same drilling rig to which the now established relationship relates.

The processor module 25 may be configured so as to control or manage the operation of the system 5 to provide (or coordinate) the processing functionality as outlined herein. Programming of the processor module 25 for carrying out any of the functions/tasks (as described herein) can be implemented in any appropriate manner, such as a software that implements the aspects of the principles described herein.

The processor module can be configured in many ways for communications purposes. The processor module 25 may be configured so as to be capable of receiving one or more signals (for example, from an electronic device (portable or otherwise, and which could be operable by way of a user or having been suitably programmed by a user) such as a control station, a tablet device, mobile phone, remote transmitting device and the like). A signal could also be transmitted by the electronic device causing or implementing any type of operational event to occur. Thus, the processor module 25 could be operable with a communication module (not shown) so that control signals/commands can be received from the electronic device. Such an electronic device could communicate with the processor module 25 using sufficiently equipped near field communication (NFC). Any suitable wireless protocol(s) could also be used, such as for example, bluetooth. The processor module 25 may be configured for controlling or managing all operations of the system 5 during use, independently or with input from the electronic device or other computing system/network.

The processor module 25 may comprise a processor which could include one or more cores that may enhance speed and performance of a multiprocessor. In some embodiments, such a processor may be a dual core processor, quad core processors, other chip-level multiprocessor and the like that combine two or more independent cores.

Operations conducted by the processor module 25 may be by way of an appropriate computing system including one or more computing devices (networked or otherwise). Examples of suitable computing devices would be readily known by those skilled in the computer sciences. Suitable computing devices may include: computing devices developed by the Raspberry Pi Foundation (for example, the Raspberry Pi 1, 2, 3, 4 models A, B, Pi Zero (including+models)), BeagleBoard.org Foundation (for example, PocketBeagle, BeagleBoard X-15), single board computers (SBC) including but not limited to Banana Pi (Banana Pi M64), Banana Pro, Odroid (Odroid-C2, Odroid-XU4), Asus Tinker Board, BBC Micro Bit, UDOO, Pine Microsystems (Pine A64-LTS), Intel Edison, Cubieboard, PanadaBoard, CuBox, Onion Omega2Plus, Rock64 Media Board, Arduino Mega, Le Potato, Orange Pi Plus2, NanoPC-T3 Plus, Latte Panda, MinnowBoard Turbot, Huawei HiKey, and including all variants of those mentioned.

The methods/processes described herein may be implemented as a computer application, computer service, computer API, computer library, and/or other computer program product. Any such computing system could include a logic subsystem and a data-holding subsystem. The computing system may optionally include a display subsystem, communication subsystem, and/or other components. Such a computing system may also optionally include user input devices such as keyboards, mice, game controllers, cameras, microphones, and/or touch screens, for example. One or more logic subsystems may include one or more physical devices configured to execute one or more instructions. For example, any such logic subsystem may be configured to execute one or more instructions that are part of one or more applications, services, programs, routines, libraries, objects, components, data structures, or other logical constructs that could be operated by the electronic device and or the processor module 25. Such instructions may be implemented to perform a task, implement a data type, transform the state of one or more on-board devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more on-board devices, which may be remotely located and/or configured for coordinated processing. One or more aspects of the logic subsystem may be virtualized and executed by remotely accessible networked computing devices configured in a cloud computing configuration.

The processor module 25 may comprise various forms of data-holding systems for the storage of relevant and/or software instructions. Such data-holding systems (and/or related subsystems) may include one or more physical, non-transitory, devices configured to hold data and/or instructions executable by the logic subsystem to implement embodiments of the methods/processes described herein.

Data-holding subsystems may include removable media and/or built-in devices. Data-holding subsystems may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystems may include devices with one or more of the following characteristics: volatile, nonvolatile, dynamic, static, read/write, read-only, random access, sequential access, location addressable, file addressable, and content addressable. In some embodiments, logic subsystems and data-holding subsystems may be integrated into one or more common devices, such as an application specific integrated circuit or a system on a chip.

Software or program instructions operated by the processor module 25 may be associated (directly or indirectly) with a client (operable, for example, for transferring instructions to the processor module 25) that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, processes, programs or codes as described herein and elsewhere may be executed by the client. In addition, other devices required for execution of methods, processes as described in this application may be considered as a part of the infrastructure associated with the client. The client may provide an interface to other devices including, without limitation, servers, cloud servers, other clients, printers, database servers, print servers, file servers, communication servers, distributed servers and the like. Additionally, this coupling and/or connection may facilitate remote execution of one or more programs across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In such implementations, remote repositories may act as a storage medium for program code, instructions, and programs.

The skilled reader would readily appreciate the nature of the materials appropriate for making or configuring an embodiment of the system 5 described herein operate in accordance with the disclosed principles. The skilled reader would be well aware of other materials, hardware, or methods for modifying such materials, hardware, could be employed for application. Similarly, the skilled reader would be aware of the components used to form of constructing/using/implementing various embodiments of the system 5 and related method 100, 200, 400 outlined herein.

Accordingly, broadly, when appropriately enabled, the principles described herein seek, in at least one respect, to allow for a metric indicative of the value of the deposit being drilled/explored to be developed/determined—either while the borehole is being drilled, or subsequently, with the view to avoiding the need for subsequent (and specific) wireline runs being carried out down the borehole once it is drilled (as is the case for conventional exploratory drilling). In this manner, significant savings in operational time (and associated cost) have the potential to be realised.

Future patent applications may be filed in Australia or overseas on the basis of, or claiming priority from, the present application. It is to be understood that the following claims are provided by way of example only and are not intended to limit the scope of what may be claimed in any such future application. Features may be added to or omitted from the provisional claims at a later date so as to further define or re-define the invention or inventions.

1. A system for use in providing an approximation or estimation of a characteristic of a deposit subject to a drilling operation by way of a drilling assembly, the system comprising:
a processor module configured operable for receiving data/information derived from a network of sensors operable for measuring one or more parameters relating to the operation of the drilling assembly, and processing the data/information so as to provide a representation of incursion into the deposit achieved by way of the drilling assembly as a function of depth,
the processor module further configured for processing said representation in accordance with a predetermined relationship characteristic unique to the individual drilling assembly for providing an approximation or estimation of the characteristic of the deposit as a function of one or more parameters representative of the incursion.

2. A system according to claim 1, wherein the characteristic of the deposit for which an approximation is sought, is its density or bulk density.

3. A system according to claim 1, wherein one of the one or more parameters representative of the incursion is the rate of penetration achieved by the drilling assembly conditioned or processed as a function of depth.

4. A system according to claim 3, wherein the rate of penetration is initially determined or calculated from the data/information received from the network of sensors as a function of time, and processed so as to convert the time-based rate of penetration so as to be provided as a function of depth.

5. A system according to claim 1, wherein the predetermined relationship characteristic of the drilling assembly is determined by way of the processor module configured operable for receiving data/information derived from the network of sensors and processing the data/information so as to provide:
a set of data representative of incursion into the deposit achieved by way of the drilling assembly as a function of depth, and
a further set of data representative of a geophysical property as a function of depth,
the processor module further configured for processing the sets of data to generate a representation of a correlation between both sets of data.

6. A system according to claim 5, wherein said further set of data representative of a geophysical property as a function of depth is derived from wireline log data.

7. A system according to claim 5, wherein the representation of a correlation between both sets of data is achieved by way of a mathematical or statistical regression technique.

8. (canceled)

9. A system according to claim 1, wherein one or more of the sensors or sensor modules are configured to:
(i) measure respective parameters of the surface assembly; and or
(ii) measure respective parameters of the downhole assembly.

10. (canceled)

11. A system according to claim 1, wherein the processor module is configured operable via the network of sensors for receiving, monitoring, sampling, recording, logging, processing any of the following data/information or parameters: a measure of the depth a drill head or bit is below ground; a measure of the state of the drill string, a measure of a rate of penetration of the drill head or bit; a measure of a penetration per revolution of the drill head or bit; a measure of a depth of the relevant borehole.

12. A system according to claim 1, wherein the processor module is configured operable via the network of sensors for receiving, monitoring, sampling, recording, logging, processing data/information in respect of a drill head of a drilling device of the drilling assembly, such data/information comprising any of the following parameters: a measure of a position of the drill head; a measure of a velocity of the drill head.

13. A system according to claim 12, wherein the processor module is configured operable via the network of sensors for receiving, monitoring, sampling, recording, logging, processing data/information in respect of rotation of the drill head, such data/information comprising any of the following parameters: a measure of an angular position of the drill head; a measure of a rate of rotation of the drill head; a measure of a torque that the drill head is subject to.

14. (canceled)

15. (canceled)

16. (canceled)

17. A system according to claim 3, wherein a process of converting the rate of the penetration of the drilling assembly from a time-based measure to one as a function of depth, comprises the following:
identifying a value relating to a maximum bit depth, and setting this value zero,
initializing an array for receiving a sequence of rate of penetration data prepared as a function of depth,
generating a sequence of data comprising times and the obtained bit depth corresponding to respective times,
generating a sequence of data comprising time and the obtained rate of penetration data corresponding to respective times,
for each data instance in the time-based rate of penetration sequence of data:
determine the bit depth corresponding to the relevant or selected time,
if the calculated/determined bit depth is found to be greater than the current maximum bit depth, add new data reflecting same to the existing data sequence, and update the current maximum bit depth value to equate with the newly calculated bit depth.

18. A system according to claim 17, wherein a wireline density and depth-based rate of penetration data are processed as appropriate using any relevant/appropriate interpolation and/or filtering techniques to smooth out any obvious/prejudicial anomalous data.

19. A system according to 18, wherein the wireline density and rate of penetration data, with any anomalous data removed, is processed so as to correlate the two sets of data as a function of depth.

20. A system according to 19, wherein with both sets of data processed as a function of depth, the depth-based wireline density data is correlated with the depth-based rate of penetration data in a linear or non-linear manner so as to calculate one or more sets of coefficients defining the relevant correlation.

21. (canceled)

22. A system according to claim 1, wherein improved accuracy or refinement of the predetermined relationship characteristic of the drilling assembly is by way of assessment or processing of data/information relating to more than one boreholes drilled using the same drilling assembly.

23. A system according to claim 22, wherein data from more than one boreholes drilled using the same drilling assembly is used to achieve an R² value of greater than 0.6.

24. A system according to claim 4, wherein the rate of penetration is a rate of penetration of a reverse circulation drill into the deposit.

25. A system according to claim 1, wherein the drilling device comprises a hammer drill.

26. A method for use in determining or providing an approximation or estimation of a characteristic of a deposit subject to a drilling operation by way of a drilling assembly, the method comprising:
receiving, by a processor module, data/information derived from a network of sensors operable for measuring a number of parameters relating to the operation of the drilling assembly,
processing, by the processor module, the data/information so as to provide a representation of incursion into the deposit achieved by way of the drilling operation rationalised as a function of depth,
processing, by the processor module, said representation in accordance with a predetermined relationship characteristic of or unique to the individual drilling assembly for providing an approximation or estimation of the characteristic of the deposit as a function of one or more parameters representative of the incursion.

27. A method for determining an approximation or estimation of a geophysical property of a deposit subject to a drilling operation by way of an individual drilling assembly, the method comprising:
receiving, by a processor module, data/information derived from a network of sensors operable for measuring a number of parameters relating to the operation of the individual drilling assembly,
processing, by the processor module, the data/information so as to provide:
a set of data representative of incursion into the deposit achieved by way of the individual drilling assembly as a function of depth, and
a further set of data representative of a measured or identified geophysical property of the deposit as a function of depth,
processing, by the processor module, the sets of data to generate a representation of a correlation between both sets of data unique to the individual drilling assembly.

28. A method according to claim 26, wherein the method serves as a calibration process for the drilling assembly.

29. (canceled)

30. (canceled)

31. (canceled)
